(19) United States
(12) Patent Application Publication
(10) Pub. No.: US 2023/0040229 A1
(43) Pub. Date: Feb. 9, 2023

(54) SUPPORT STRUCTURE FOR A SPACECRAFT AND METHOD OF ASSEMBLING SAME

(71) Applicant: AIRBUS DEFENCE AND SPACE SAS, Toulouse Cedex 4 (FR)

(72) Inventor: Andrew WALKER, Toulouse Cedex 4 (FR)

(21) Appl. No.: 17/788,578

(22) PCT Filed: Dec. 23, 2020
(86) PCT No.: PCT/FR2020/052613

§ 371 Date: Jun. 23, 2022

(30) Foreign Application Priority Data
Dec. 24, 2019 (FR) FR1915561

(51) Int. Cl. B64G 1/50; B64G 1/66

(52) U.S. Cl. CPC B64G 1/506; B64G 1/66; B64G 1/503

(57) ABSTRACT

A support structure for a spacecraft is disclosed having a first side wall, a second side wall which is parallel to and opposite the first side wall, a third side wall attached to at least the first side wall, and a fourth side wall which is parallel to and opposite the third side wall; at least one interior panel attached between and perpendicular to the first side wall and to the second side wall, at least one first thermal coupling device bearing against the second side wall and attached to the interior panel, electronic devices arranged on and in direct thermal contact with at least a portion of the first thermal coupling device.

### TECHNICAL FIELD OF THE INVENTION

This invention falls within the field of spacecraft, and in particular within the field of geostationary satellites.

### PRIOR ART

Spacecraft contain electronic devices that release heat during operation. This heat is dissipated by radiators mounted on the North and South walls of the spacecraft. Spacecraft manufacturers are seeking to improve the cooling of electronic devices in order to ensure that they have a longer lifespan.

Documents EP 3,003,862, U.S. Pat. Nos. 5,735,489, and 6,478,258 describe satellites equipped with a heat transfer device.

A first object of this invention is to improve the heat rejection of spacecraft.

Moreover, due to the revolution of the Earth about the Sun, the different faces of geostationary spacecraft do not receive the same amount of solar radiation over the various seasons. This results in significant temperature differences between the North 30 and South 32 walls of the spacecraft as well as cyclical variations in these temperatures over the various seasons, as can be seen in FIG. 1. These temperature differences between the North 30 and South 32 walls as well as temperature fluctuations over the various seasons are stressful for spacecraft and for their payload.

A second object of this invention is to improve the heat transfer between the North and South walls of spacecraft. Increasing this heat transfer also makes it possible to increase the overall heat rejection of the spacecraft.

Generally, spacecraft have an amplifier and a redundant amplifier which are connected to each communication antenna. The redundant amplifier is used in case of failure of the amplifier. As the amplifiers emit a lot of heat, the amplifiers and redundant amplifiers are attached to the walls equipped with radiators—i.e. the North and South walls—in order to be able to discharge the large amount of heat that they release. A single redundant amplifier for the two main antennas is not used, because this would require installing electrical cables and waveguides between the two walls. Installing these cables and these waveguides would significantly increase the weight of the spacecraft and increase its price.

A third object of this invention is to reduce the number of amplifiers mounted in the spacecraft while fulfilling the redundancy function that enables replacing an amplifier in the event of its failure.

A fourth object of this invention is to increase the number of electronic devices that can be attached in the spacecraft.

This invention also relates to a new method of assembling a support structure for a spacecraft. Generally, the assembly of the spacecraft begins with a first step illustrated in FIG. 8, during which heat pipes 52 are attached next to each other on the North wall 30, the South wall 32, and the West wall 24.

Then, during a second step illustrated in FIG. 9, electronic devices 50 are attached over the whole surface of the North wall and South wall with the exception of a side edge 90 on which no device is mounted. Electronic devices 50 are also attached over the whole surface of the West wall except for two side edges 90 on which no device is mounted. The electronic devices 50 on each wall are then interconnected by electrical connections 91. During this step, no electrical connection is made between electronic devices mounted on different walls.

During a third step illustrated in FIG. 10, the West wall 24 is attached to the North wall 30 and to the South wall 32. A thermal coupling heat pipe 92 is attached between the North wall 30 and the West wall 24. Another thermal coupling heat pipe 93 is attached between the West wall 24 and the South wall 32. These coupling heat pipes 92, 93 are attached onto the side edges 90 not equipped with electronic devices. The coupling heat pipes 92, 93 comprise two branches perpendicular to each other. Each branch has a length of about 200 millimeters. No electronic device is attached to the thermal coupling heat pipes.

During a fourth step illustrated in FIG. 11, the electrical connections 94 are established between electronic devices attached to different walls. The electrical assembly is then tested.

During this test, the operator verifies that the electrical connections 91, 94 between all the electronic devices attached to the three walls 24, 30, 32 are working.

A fifth object of this invention is to provide a faster method of assembling a support structure for a spacecraft.

A sixth object of this invention is to propose an assembly method that uses a greater number of standard components.

### Presentation of the Invention

A first object of this invention is to improve the heat rejection of spacecraft.

A second object of this invention is to improve the heat transfer between the North wall and the South wall of spacecraft.

A third object of this invention is to reduce the number of amplifiers mounted in spacecraft while fulfilling the redundancy function that enables replacing an amplifier in the event of its failure.

A fourth object of this invention is to increase the number of electronic devices that can be attached in the spacecraft.

A fifth object of this invention is to provide a faster method of assembling a support structure for a spacecraft.

A sixth object of this invention is to propose an assembly method that uses a greater number of standard components.

### SUMMARY OF THE INVENTION

This invention relates to a support structure for a spacecraft, comprising a first side wall, a second side wall which is parallel to and opposite the first side wall, the first side wall (30) being a wall among a North wall and a South wall, the second side wall (32) being the other wall among a North wall and a South wall, a third side wall attached to at least the first side wall, and a fourth side wall which is parallel to and opposite the third side wall, the first side wall and the second side wall each being equipped with a radiator, characterized in that it further comprises:
at least one interior panel attached between and perpendicular to the first side wall and to the second side wall, the interior panel being positioned equidistant from the third side wall and the fourth side wall; when the spacecraft containing the support structure is in orbit around the Earth, the interior panel is positioned so as to contain a vector directed towards the Earth; the interior panel has a main face and an opposite main face;
at least one first heat pipe that is L-shaped, having a first branch bearing against the second side wall and a second branch (62) attached to the interior panel, the second branch of the first heat pipe having in its rectilinear portion a length greater than 80% of the distance between the first side wall and the second side wall;
electronic devices arranged on and in direct thermal contact with at least a portion of said first heat pipe.

Advantageously, as the interior panel is equidistant from the third side wall and from the fourth side wall, the thermal coupling devices which are attached to each side of the interior panel are identical. This results in a standardization of the manufacturing process and a reduction in the manufacturing cost.

Advantageously, this support structure makes it possible to mount high-power electronic components on the interior panel. This results in saved space, enabling the installation of a greater number of devices.

The features set forth in the following paragraphs may optionally be implemented. They may be implemented independently of each other or in combination with each other:
The structure comprises at least one second heat pipe that is L-shaped, having a first branch bearing against the first side wall and a second branch bearing against the interior panel, the second heat pipe being able to exchange heat with the first heat pipe, said support structure further comprising electronic devices arranged on and in direct thermal contact with said second heat pipe.

Advantageously, this spacecraft thus has better thermal coupling between the North wall and the South wall.
The second branch of the second heat pipe is in direct thermal contact with the second branch of the first heat pipe, the second branch of the second heat pipe being attached against the second branch of the first heat pipe.
The second branch of the first heat pipe is attached against the main face of the interior panel and the second branch of the second heat pipe is attached against the opposite face of the interior panel.
The second side wall comprises a first zone and a second zone which are delimited by the interior panel, the first branch of the first heat pipe bearing against the first zone of the second side wall, the second branch of the first heat pipe being attached to the main face of the interior panel, said support structure further comprising a first additional heat pipe having a first branch bearing against the second zone of the second side wall and a second branch attached against the opposite main face of the interior panel.

The structure comprises rectilinear heat transfer devices attached to said second side wall, the first heat pipe being attached against said heat transfer devices and being in direct thermal contact with said heat transfer devices.

The structure comprises rectilinear heat transfer devices attached to said first side wall, said at least one second heat pipe being attached to said heat transfer devices and being in direct thermal contact with said heat transfer devices.

The structure comprises a first main antenna and a second main antenna, said electronic devices comprise a first amplifier attached to the first side wall and connected to the first main antenna, a second amplifier attached to the second side wall and connected to the second main antenna, and a single redundant amplifier attached against the interior panel and connected to the first main antenna and to the second main antenna.
The first branch of one among the first heat pipe and the second heat pipe has a length between 0.5 meters and 1.5 meters, and preferably between 0.7 meters and 1 meter.
The second branch of the first heat pipe has a length between 2 meters and 2.7 meters and preferably between 2.4 meters and 2.7 meters.
The second branch of the second heat pipe has a length between 1 meter and 1.5 meters, preferably between 1.2 meters and 1.4 meters.

The invention also relates to a method of assembling a support structure for a spacecraft starting with a first side wall, a second side wall, an interior panel having a main face and an opposite main face, and at least one first heat pipe having a first branch and a second branch, the second branch of the first heat pipe having in its rectilinear portion a length greater than 80% of the distance between the first side wall and the second side wall, the method comprising the following consecutive steps:

a) attaching said interior panel between and perpendicular to the first side wall and to the second side wall, the interior panel being positioned so as to contain a vector (V) directed towards the Earth, when the spacecraft containing the support structure is in orbit around the Earth,

b) mounting the first branch of said at least one first heat pipe so as to bear against the second side wall and attaching said second branch of said at least one first heat pipe to the interior panel;

c) attaching electronic devices against the first branch of said at least one first heat pipe; and attaching electronic devices against at least a portion of the second branch of said at least one first heat pipe, and

e) connecting the electronic devices by electrical connections, at least one electronic device attached to the interior panel being electrically connected to an electronic device attached to the first side wall,

f) testing the electrical connections between the electronic devices.

The features set forth in the following paragraphs may optionally be implemented. They may be implemented independently of each other or in combination with each other:

The method further comprises a step of mounting the first branch of at least one second heat pipe so as to bear against the first side wall and of attaching the second branch of said at least one second heat pipe against, and in direct thermal contact with, a portion of the second branch of the at least one first heat pipe; said attachment step being implemented between mounting step b) and attachment step c); electronic devices being attached to the first side wall against the first branch of the second heat pipe, and on the interior panel against the second branch of the second heat pipe, during attachment step c).

The interior panel comprises at least one through-hole and the method further comprises a step of establishing at least one electrical connection between at least one electronic device attached to the main face of the interior panel and an electronic device attached to the opposite main face of the interior panel, said electrical connection passing through said through-hole.

The electronic devices are attached over the whole of the second branch of said at least one first heat pipe during attachment step c).

### BRIEF DESCRIPTION OF FIGURES

FIG. 1 is a schematic view of a spacecraft comprising a support structure according to the invention, in geostationary orbit;

FIG. 2 is a schematic perspective view of part of a spacecraft comprising a support structure according to a first embodiment of the invention;

FIG. 3 is a schematic view of a cross-section of the spacecraft comprising a support structure according to the first embodiment of the invention, in which the electronic devices have not been represented;

FIG. 4 is a schematic perspective view of part of a support structure for a spacecraft according to the first embodiment of the invention;

FIG. 5 is a schematic view of a cross-section of a spacecraft comprising a support structure according to the first embodiment of the invention, in which the amplifiers have been represented;

FIG. 6 is a schematic perspective view of part of a support structure for a spacecraft according to a second embodiment of the invention;

FIG. 7 is a schematic perspective view of part of a support structure for a spacecraft according to a third embodiment of the invention;

FIG. 8 is a schematic view of a first step of a method of assembling a spacecraft according to the prior art;

FIG. 9 is a schematic view of a second step of a method of assembling a spacecraft according to the prior art;

FIG. 10 is a schematic view of a third step of a method of assembling a spacecraft according to the prior art;

FIG. 11 is a schematic view of a fourth step of a method of assembling a spacecraft according to the prior art;

FIG. 12 is a diagram of the steps of the assembly method according to this invention;

FIG. 13 is a schematic view of a first step of a method of assembling a support structure for a spacecraft according to a first embodiment of the invention;

FIG. 14 is a schematic view of a second step of a method of assembling a support structure for a spacecraft according to a first embodiment of the invention;

FIG. 15 is a schematic view of a third step of a method of assembling a support structure for a spacecraft according to a first embodiment of the invention;

FIG. 16 is a schematic view illustrating an assembling of electronic devices in a spacecraft comprising a support structure according to the invention;

FIG. 17 is a schematic view illustrating another assembling of electronic devices in a spacecraft comprising a support structure according to the invention;

FIG. 18 is a schematic view of an optional step of the method of assembling a support structure for a spacecraft according to the invention;

FIG. 19 is a schematic view of a variant of the method of assembling a support structure for a spacecraft according to the invention;

FIG. 20 is a schematic section view of a spacecraft wall on which heat pipes without side edges have been mounted;

FIG. 21 is a schematic section view of a spacecraft wall according to the prior art, said section being at the attachment screws of an electronic component.

### DETAILED DESCRIPTION OF THE INVENTION

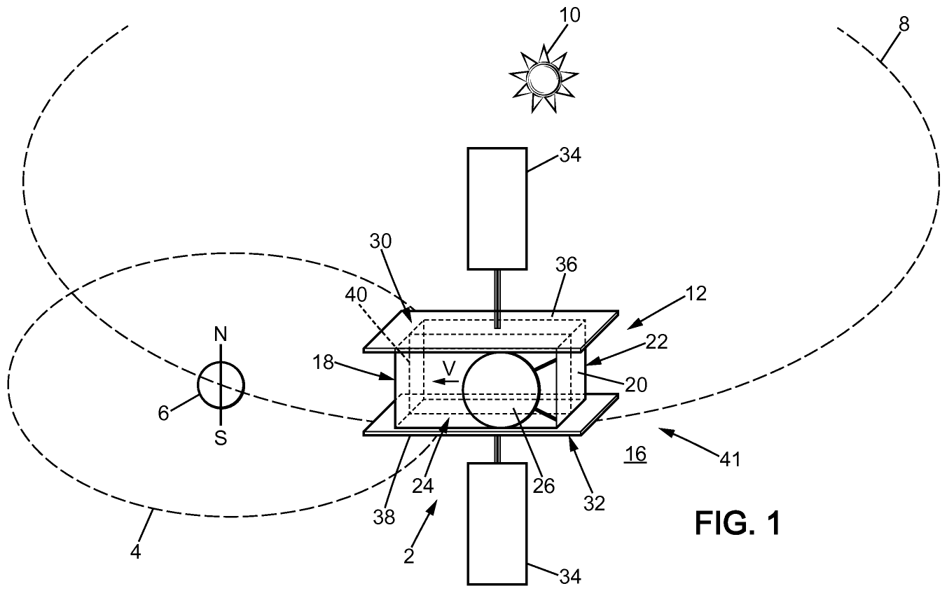

With reference to FIG. 1, a spacecraft 2 of the geostationary satellite type is capable of rotating in an orbit 4 around the Earth 6, the Earth 6 itself rotating in an orbit 8 around the Sun 10.

The spacecraft 2 is in the form of a box 12 of parallelepipedic shape delimiting an interior space 14 and an exterior space 16. This box 12 always has the same wall directed towards the Earth, this wall being called the Earth wall 18. The opposite wall parallel to the Earth wall 18 is called the anti-Earth wall 20.

This box 12 comprises a North wall 30 or −Y wall, and a South wall 32 or +Y wall. The North wall and the South wall are opposite, parallel to each other and parallel to the North-South axis of the Earth 6. The North wall 30 and the South wall 32 have a rectangular shape.

This box 12 also has an East wall 22 or −X wall, and a West wall 24 or +X wall. The East wall 22 and West wall 24 are opposite walls, parallel to each other and perpendicular to the direction of travel of the spacecraft 2.

By convention, in the set of claims herein, the term “first side wall” is used to designate one wall among the North wall and South wall, and the term “second side wall” is used to designate the other wall among the North wall and South wall. Similarly, the terms “third side wall” and “fourth side wall” can refer to either of the East 22 and West 24 walls.

Solar panels 34 are attached to the North wall 30 and South wall 32. A radiator 36 is attached to and extends over the North wall 30. Another radiator 38 is attached to and extends over the South wall 32. Finally, a first main communication antenna 26 is attached to the East wall 22 and a second main communication antenna 28 is attached to the West wall 24.

The spacecraft has an interior panel 40 attached to the North wall 30, South wall 32, Earth wall 18, and anti-Earth wall 20. It extends perpendicularly to the North wall 30, South wall 32, Earth wall 18, and anti-Earth wall 20. It extends along the full length of the box, from the Earth wall to the anti-Earth wall. The interior panel 40 is attached between the North wall 30 and the South wall 32. As viewed from the Earth 18 or anti-Earth 20 face, the North wall 30, the South wall 32, and the interior wall 40 together form an “H”. The interior panel 40 is positioned equidistant from the East wall 22 and the West wall 24. In other words, the interior panel 40 is positioned so as to contain a vector V directed towards the Earth, when the spacecraft containing the support structure is in orbit around the Earth.

The interior panel 40, the North wall 30, the South wall 32, and the radiators 36,38 form a support structure 41 intended to be mounted in the spacecraft 2, The interior panel 40 has a main face 42 and an opposite main face 44. The interior panel delimits two zones 46, 48 on the interior face of the North wall and two zones 46, 48 on the interior face of the South wall. A first zone 46 is located on the main face 42 side of the interior panel. A second zone 48 is located on the opposite main face 44 side of the interior panel.

The support structure 41 carries electronic devices 50 not shown in FIGS. 1, 2 and 4 to 7.

These electronic devices are attached to both sides of the interior panel 40, on the interior face of the North wall 30, and on the interior face of the South wall 32. Such electronic devices include, for example, radio frequency equipment, amplifiers, measuring instruments, computing units, and batteries.

The support structure 41 also carries rectilinear heat transfer devices 52 supported by the North wall 30, and rectilinear heat transfer devices 54 supported by the South wall 32. The heat transfer devices 52, 54 make it possible to distribute the heat released by the electronic devices 50 over the entire surface of radiator 36 and radiator 38. Each heat transfer device consists of a heat pipe.

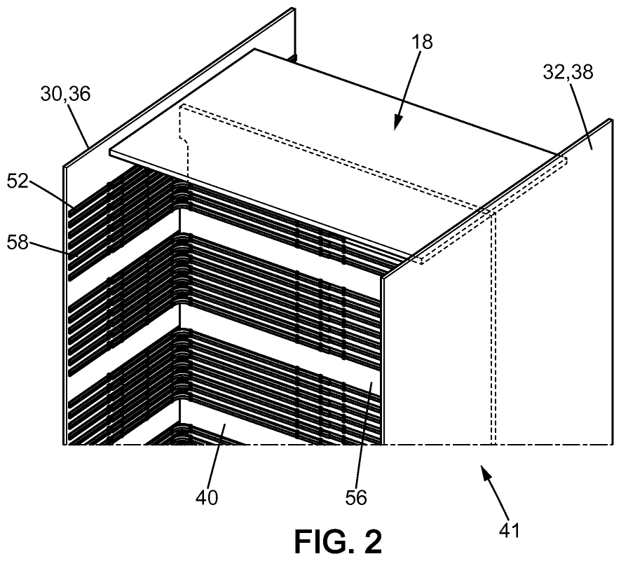

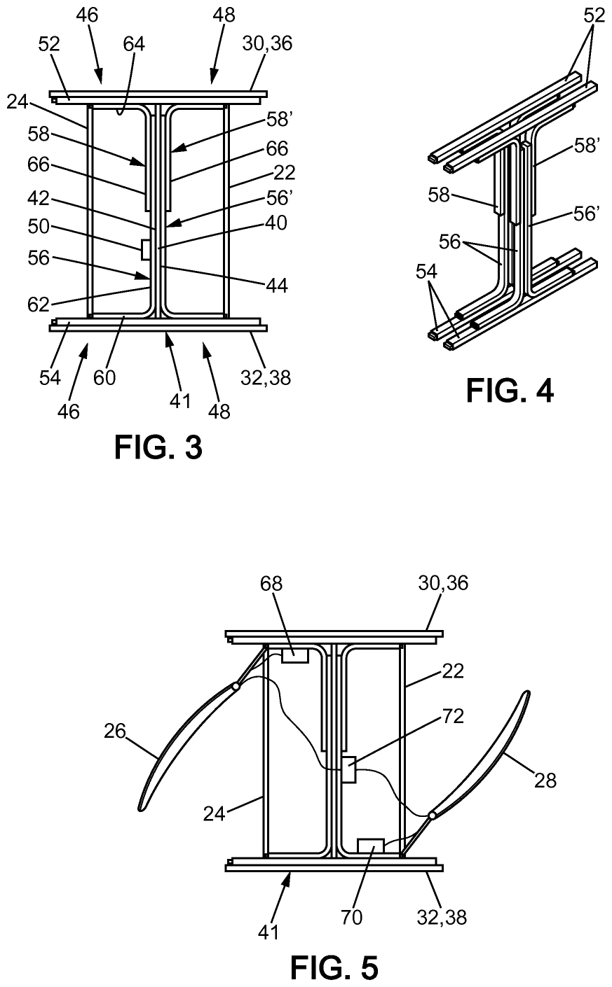

In the embodiment shown in FIGS. 2 to 4, heat transfer devices 52 are attached to the internal main face of the North wall 30. They are in direct thermal contact with the North wall and the first radiator 36. They extend along the transverse direction of the North wall 30. In the same manner, heat transfer devices 54 are attached to the internal main face of the South wall 32. They are in direct thermal contact with the South wall 32 and radiator 38.

Advantageously, the rectilinear heat transfer devices 52, 54 are attached using a thermally conductive and self-hardening paste. Thus, the rectilinear heat transfer devices 52, 54 do not include holes intended to receive attachment screws. The support structure 41 further comprises first thermal coupling devices 56 in the shape of an “L”. They have a first branch 60, and a second branch 62 perpendicular to the first branch 60.

Some first thermal coupling devices 56 are located on the main face 42 side of the interior panel. Their first branch 60 is attached to a part of the heat transfer devices 54 arranged on the first zone 46 of the South wall. Their first branch 60 is in direct thermal contact with the heat transfer devices 54. Their second branch 62 is attached to the main face 42 of the interior panel. Other first thermal coupling devices 56′ are located on the opposite main face 44 side of the interior panel. Their first branch 60 is attached to a part of the heat transfer devices 54 arranged on the second zone 48 of the South wall. Their second branch 62 is attached to the opposite main face 44 of the interior panel.

The first branch 60 of the first devices 56 has a length greater than 80% of the distance between the interior panel 40 and the West wall 24.

The second branch 62 of the first devices 56 has, in its rectilinear portion, a length of between 80% and 100% of the distance between the North wall and the South wall.

Preferably, the length of the second branch of the first coupling devices is between 90% and 100%. For example, the first branch 60 has a length between 1 meter and 1.5 meters, and preferably a length between 0.7 meters and 1 meter. Advantageously, the first branch 60 has a length equal to 1.2 meters. The second branch 62 has, for example, a length between 2 meters and 2.7 meters, and preferably a length between 2.4 meters and 2.7 meters.

Advantageously, the second branch 62 has a length equal to 2.5 meters.

Advantageously, the first thermal coupling devices 56, 56′ located one on each side of the interior panel 40 are identical.

The support structure 41 further comprises second thermal coupling devices 58 in the shape of an “L”. The second devices 58 also have a first branch 64, and a second branch 66 perpendicular to the first branch 64. Their second branch 66 has a length equal to half the distance between the North wall 30 and the South wall 32.

Some second thermal coupling devices 58 are located on the main face 42 side of the interior panel. Their first branch 64 is attached to a part of the heat transfer devices 52 arranged on the first zone 46 of the North wall. Their first branch 64 is in direct thermal contact with the heat transfer devices 52. Their second branch 66 is attached to the second branch 62 of the first devices 56. Their second branch 66 is in direct thermal contact with the second branch 62 of the first devices. Other second thermal coupling devices 58′ are located on the opposite main face 44 side of the interior panel. Their first branch 64 is attached to a part of the heat transfer devices 52 arranged on the second zone 48 of the North wall. Their second branch 66 is attached to, and is in direct thermal contact with, the second branch 62 of the first thermal coupling devices.

Advantageously, the second thermal coupling devices 58, 58′ located one on each side of the interior panel 40 are identical.

Advantageously, the thermal coupling devices 56, 56′, 58, 58′ are also attached using heat-conductive and self-hardening paste. The thermal coupling devices 56, 56′, 58, 58′ thus do not include holes intended to receive attachment screws.

The first 56, 56′ and second 58, 58′ thermal coupling devices thermally connect the electronic devices 50 attached to the interior panel 40, to radiator 36 and/or to radiator 38.

Referring to FIG. 5, the electronic devices 50 comprise a first amplifier 68 fixed to the North wall and a second amplifier 70 fixed to the South wall. The first amplifier 68 is electrically connected to the first main antenna 26 so as to be able to amplify the signals before their transmission. The second amplifier 70 is electrically connected to the second main antenna 28. Advantageously, the support structure 41 for the spacecraft 2 according to the invention comprises a single redundant amplifier 72 attached to the interior panel 40. The redundant amplifier 72 is electrically connected to the first main antenna 26 and to the second main antenna 28.

Advantageously, the support structure 41 according to this first embodiment has high thermal coupling between the North wall 30 and the South wall 32.

Preferably, the support structure 41 comprises first and second thermal coupling devices arranged next to each other to cover the whole of the North wall 30 and South wall 32.

Advantageously, only two types of elbow heat pipes are mounted on the support structure of the satellite. This results in a standardization of the satellite's heat pipes.

Advantageously, the rectilinear heat transfer devices 52, 54 and the thermal coupling devices 56, 58 are components having standard dimensions. As a result, it is no longer necessary to order custom heat pipes and to maintain an inventory of capillary heat pipes.

Advantageously, the location of the interior panel makes it possible to attach electronic components 50 on each side of the interior panel 40. A greater number of electronic components can thus be mounted on the support structure of the satellite. Also advantageously, these electronic components can be attached quickly and easily.

Alternatively, the support structure 41 comprises first and second thermal coupling devices arranged next to each other to cover certain portions of the North wall 30 and South wall 32, in order to increase the heat transfer for those wall portions. Such an alternative may, for example, be used when an electronic device that releases a lot of heat is mounted on these wall portions or on the corresponding portion of the interior panel.

Alternatively, the support structure 41 comprises a single heat transfer device 52 attached to the North wall and a single heat transfer device 54 attached to the South wall.

Alternatively, the rectilinear heat transfer devices are integrated into the North wall and South wall. In this case, the thermal coupling devices are attached to the North wall and to the South wall.

The support structure 41 for a spacecraft according to a second embodiment is identical to the support structure according to the first embodiment, except that it does not include second coupling devices 58 and that one out of two first coupling devices is facing in the opposite direction. The support structure for a spacecraft according to the second embodiment has not been shown in its entirety and will not be described again in its entirety.

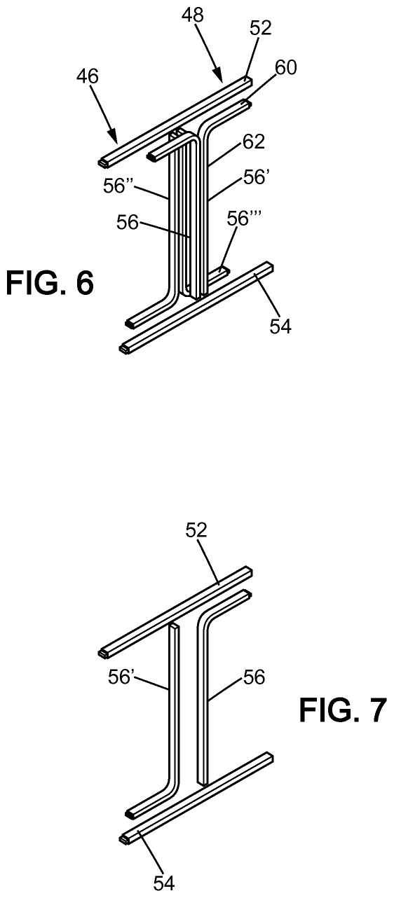

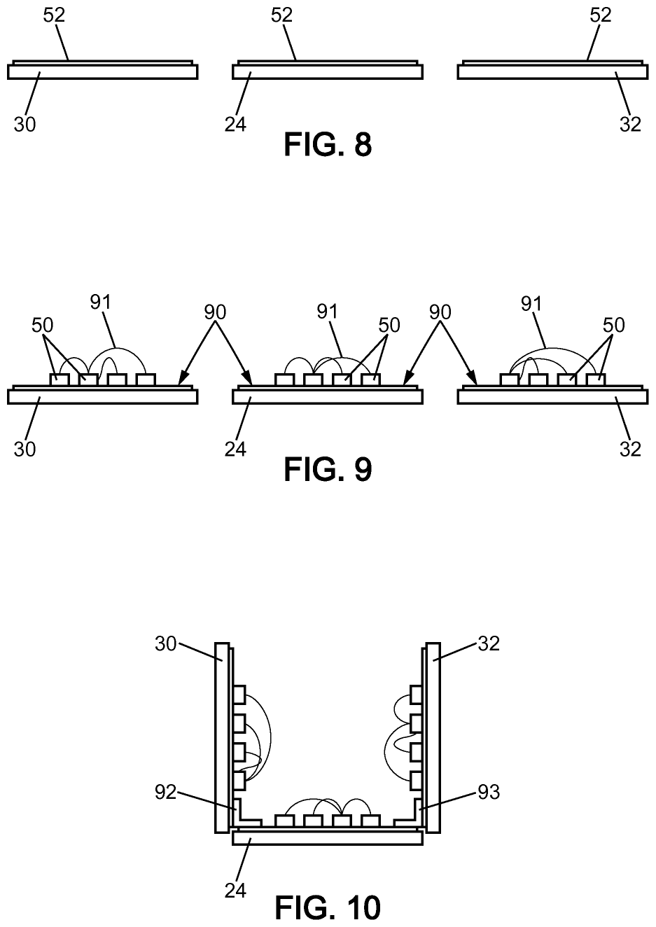

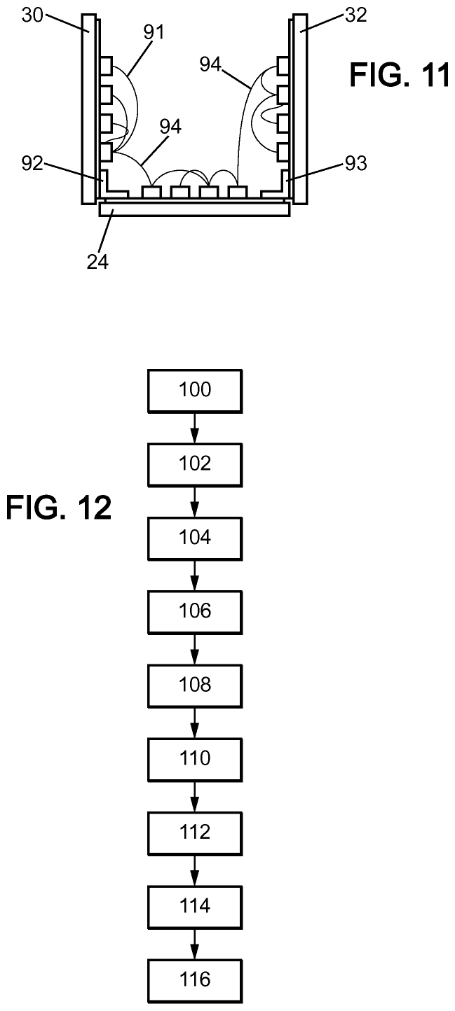

Only the heat transfer devices 52, 54 and the thermal coupling devices of the support structure according to this second embodiment will be described. Thus, with reference to FIG. 6, the support structure 41 according to the second embodiment comprises:
a rectilinear heat transfer device 52 in contact with the North wall 30,
a first thermal coupling device 56 having a first branch 60 attached to, and in direct thermal contact with, a part of the rectilinear heat transfer device 52, said part being located on the first zone 46 of the North wall, and a second branch attached to the main face 42 of the interior panel (not shown);
a first thermal coupling device 56′ having a first branch 60 attached to, and in direct thermal contact with, another part of the rectilinear heat transfer device 52, said part being located on the second zone 48 of the North wall, and a second branch 62 attached to the opposite main face 44 of the interior panel (not shown in FIG. 6);
a rectilinear heat transfer device 54 in contact with the South wall 32,
a first thermal coupling device 56″ having a first branch 60 attached to and in direct thermal contact with a part of the rectilinear heat transfer device 54, said part being located on the first zone 46 of the South wall 32, and a second branch attached to the main face 42 of the interior panel (not shown in FIG. 6); and
a first thermal coupling device 56′″ having a first branch 60 attached to and in direct thermal contact with another part of the rectilinear heat transfer device 54, said part being located on the second zone 48 of the South wall, and a second branch 62 attached to the opposite main face 44 of the interior panel (not shown in FIG. 6).

The support structure for a spacecraft according to the second embodiment comprises several assemblies as illustrated in FIG. 6. These assemblies are arranged one beside the other.

The spacecraft comprising a support structure according to this second embodiment is lighter than the spacecraft according to the first embodiment.

Alternatively, the support structure 41 for a spacecraft comprises assemblies as illustrated in FIG. 4 on transverse portions of the support structure (namely on transverse portions of the North wall, of the interior panel, and of the South wall) and assemblies as illustrated in FIG. 6 on other transverse portions of the support structure.

The support structure for a spacecraft according to a third embodiment is identical to the support structure for a spacecraft according to the second embodiment, except that it comprises intermediate spaces in which there is no thermal coupling device. The support structure for a spacecraft according to the third embodiment has not been shown in its entirety and will not be described again in its entirety. Only the heat transfer devices 52, 54 and the thermal coupling devices of the support structure for a spacecraft according to this third embodiment will be described. Thus, with reference to FIG. 7, the support structure 41 according to the third embodiment comprises:
a rectilinear heat transfer device 52 in contact with the North wall,
a first thermal coupling device 56 having a first branch 60 attached to and in direct thermal contact with a part of the rectilinear heat transfer device 52, said part being located on the second zone 48 of the North wall, and a second branch attached to the main face 42 of the interior panel (not shown in FIG. 7);
a rectilinear heat transfer device 54 in contact with the South wall,
a first thermal coupling device 56′ having a first branch 60 attached to and in direct thermal contact with a part of the rectilinear heat transfer device 54, said part being located on the first zone 46 of the South wall, and a second branch attached to the opposite main face 44 of the interior panel (not shown in FIG. 7).

Alternatively, the support structure 41 comprises, at the same time, assemblies as illustrated in FIG. 4, assemblies as illustrated in FIG. 6, and assemblies as illustrated in FIG. 7.

This invention also relates to a method of assembling a support structure for a spacecraft in accordance with the above description.

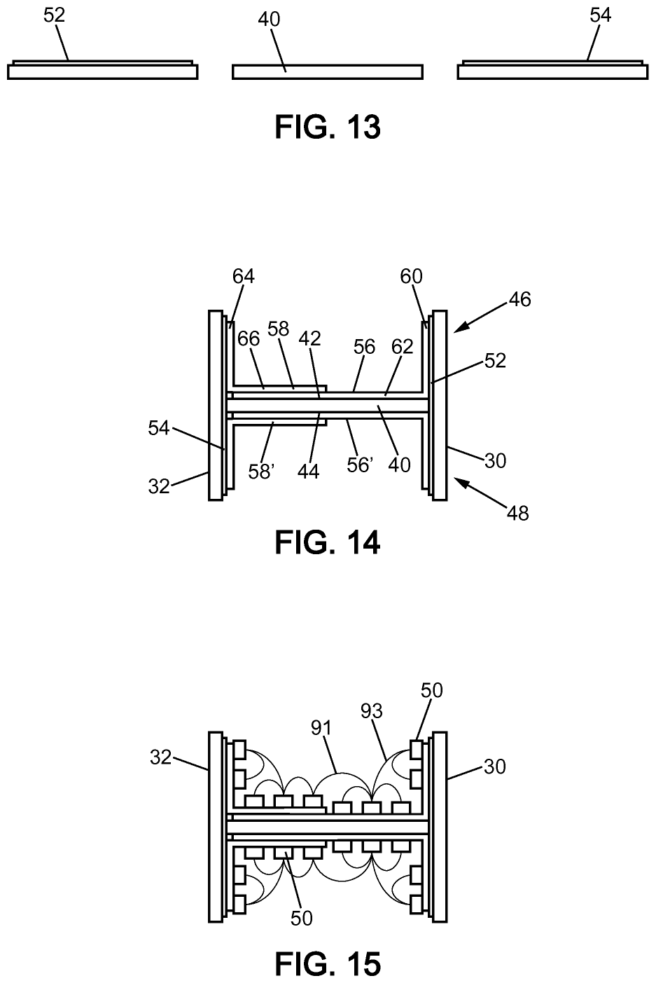

Referring to FIG. 12, the assembly method according to the invention begins with a step 100 illustrated in FIG. 13, during which rectilinear heat transfer devices 52, 54 are attached to an interior face of two panels, a radiator having been attached to the other face of these panels. These panels are intended to constitute a North wall and a South wall.

During a step 102 illustrated in FIG. 14, an interior panel 40 is fixed to the North wall 30 and to the South wall 32. The interior panel 40 is fixed between the North wall 30 and the South wall 32 and perpendicular to them.

As viewed from the Earth, the North wall 30, the South wall 32, and the interior a 40 together form an “H”.

During a step 104, first thermal coupling devices 56, 56′ are attached to the interior panel 40 and to the North wall 30. In particular, the first branch 60 of the first devices 56, 56′ is mounted so as to bear against the North wall 30.

The first branch 60 of some first devices 56 is attached to, and in direct thermal contact with, a part of the heat transfer devices 52, said part being located on a first zone 46 of the North wall 30. The second branch 62 of the first thermal coupling devices is attached to the main face 42 of the interior panel 40.

The first branch 60 of other first devices 56′ is attached to, and in direct thermal contact with, a part of the heat transfer devices 52, said part being located on a second zone 48 of the North wall 30. The second branch 62 of the first thermal coupling devices is attached to the opposite main face 44 of the interior panel 40.

During a step 106, second thermal coupling devices 58, 58′ are attached to the South wall 32 and to part of the first thermal coupling devices 56, 56′.

In particular, the first branch 64 of the second devices 58, 58′ is mounted so as to bear against the South wall 32.

The first branch 64 of some second thermal coupling devices 58 is attached to, and is in direct thermal contact with, a part of the heat transfer devices 54, said part being located on a first zone 46 of the South wall 32. The second branch 66 of the second devices 58 is attached to, and is in direct thermal contact with, a part of the first thermal coupling devices 56. The first branch 64 of other second devices 58′ is fixed to a part of the heat transfer devices 54, said part being located on a second zone 48 of the South wall 32. The second branch 66 of the second devices 58 is fixed to a part of the first thermal coupling devices 56′.

During a step 108, illustrated in FIG. 15, electronic devices 50 are attached to the North wall 30, to the interior panel 40, and to the South wall 32. In particular, electronic devices 50 are attached against the first branches 60 of the first thermal coupling devices, against the second branch 66 of the second thermal coupling devices, and against a part of the second branch 62 of the first thermal coupling devices.

Advantageously, a greater number of electronic devices 50 can be attached to the support structure according to the invention. Since the electronic devices are attached to the thermal coupling devices 56, 58, there is no “wasted” space intended solely for the thermal coupling devices 92, 93, as there is in the prior art support structures for spacecraft. This wasted space includes the side edges 90 illustrated in FIG. 9.

During a step 110, the electronic devices 50 are connected by electrical connections 91, 94. During this step, all of the electrical connections 91, 94 are made. Thus, the electronic devices 50 attached to a same wall or to the same interior panel are connected by electrical connections 91. The electronic devices 50 attached to different walls are electrically connected and the electronic devices 50 attached to the interior panel 40 are electrically connected to the electronic devices attached to the North wall and/or the South wall, by electrical connections 94.

Advantageously, the H-shaped support structure for spacecraft according to this invention facilitates accessibility to the wall and to the interior panel and makes it possible to mount a large number of electronic devices 50 very quickly and to connect them by electrical connections.

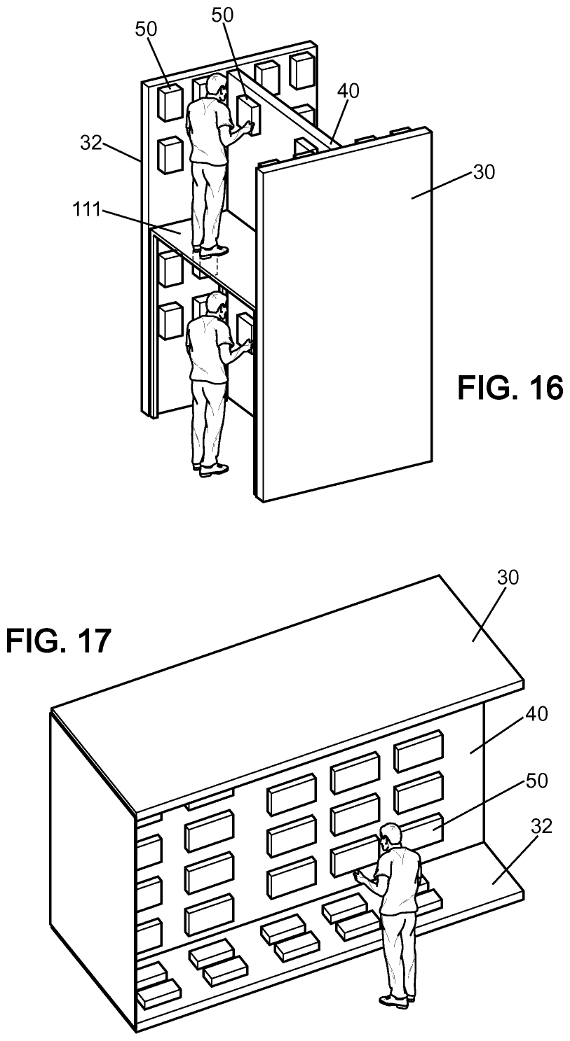

Indeed, with reference to FIG. 16, when the spacecraft comprising the support structure according to the invention is positioned vertically, using a support element 111 on each side of the interior panel 40, four operators can simultaneously attach electronic devices to the North wall, South wall 32, and each side of the interior panel. When the spacecraft comprising the support structure according to the invention is positioned horizontally as illustrated in FIG. 17, several people standing next to each other on each side of the interior wall 40 can also simultaneously attach its electronic devices. The assembly speed of the spacecraft is thus increased.

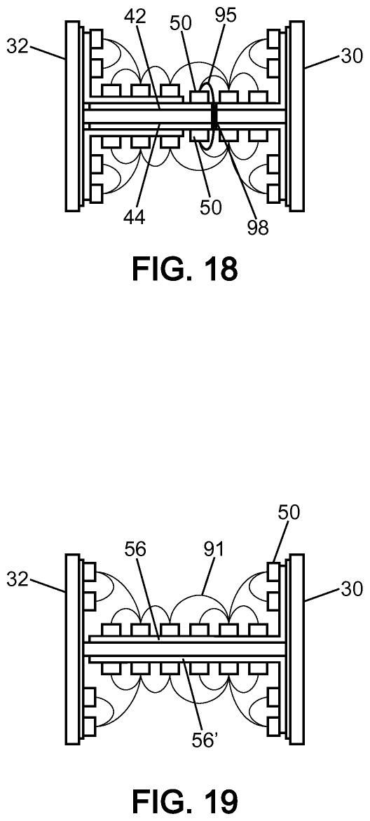

The assembly method may optionally comprise a step 112 illustrated in FIG. 18. During this step 112, an electrical connection is made between an electronic device 50 attached to the main face 42 and an electronic device 50 attached to the opposite main face 44 of the interior panel. This electrical connection 95 passes through a pre-existing through-hole 98 in the interior panel 40.

During a step 114, the electrical connections 91, 94, 95 between the electronic devices 50 are tested.

During a step 116, the third side wall 22 and the fourth side wall 24 are attached to the first side wall 30 and to the second side wall 32 such that the interior panel 40 is positioned equidistant from the third side wall 30 and from the fourth side wall 40.

Alternatively, the assembly method does not include a step 106. In this case, illustrated in FIG. 19, the electronic devices 50 are attached directly over the entire surface of the first coupling devices 56, 56′ as well on the heat transfer devices 54.

Alternatively, the transfer devices 52, 54 are integrated into the panels of the North and South walls and the first coupling devices 56 are attached directly to the North and South walls.

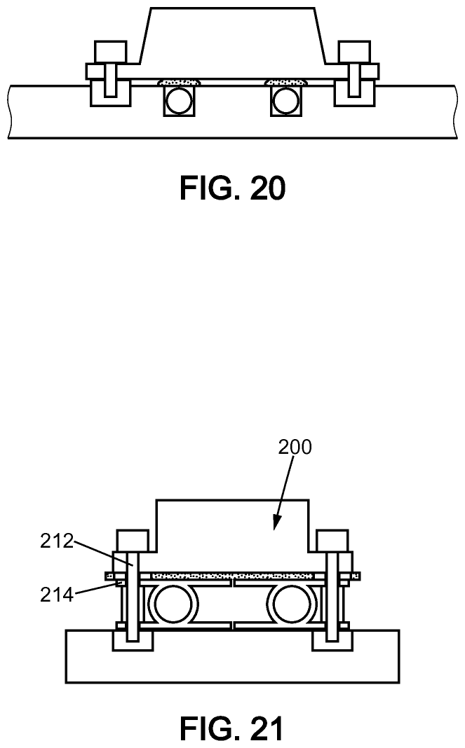

Alternatively, all or part of the heat pipes used to create the support structure are heat pipes without side edges. These heat pipes are described in the patent application published under number FR 3 089 957. Such heat pipes are illustrated in FIG. 20. These heat pipes are different from conventional heat pipes. In particular, they do not have wide side edges.

A conventional heat pipe is illustrated in FIG. 21. When a conventional heat pipe is mounted on a wall of a satellite, it is necessary to know the exact position of each electronic device prior to step 104, although attachment of the electronic devices is not implemented until step 106. Indeed, the exact position of each electronic device must be known in order to pierce holes 214 in the side edges of the heat pipe and in the interior panel 40 to enable attaching the electronic devices 200 with screws 212.

In contrast, by using heat pipes without side edges, it is no longer necessary to pierce holes in the heat pipes. The exact position of each electronic device no longer needs to be known prior to step 104. It is therefore possible to use heat pipes of standard size, starting from step 104 or even from step 100, without an additional machining operation before this step. This results in the advantages stated on page 11 lines 16 to 25 of this patent application.

In addition, it is possible to define, prior to step 104 or even prior to step 100, standard positions for the heat pipes in the structure. This makes it possible to define device installation zones with a maximum heat rejection capacity defined in advance. For example, the support structure illustrated in FIG. 2 comprises three zones of seven heat pipes each. The number of heat pipes actually installed can be adapted immediately prior to step 104. The total rejection capacity is defined by the height of the North and South walls and by the height of the interior panel 40. It is therefore possible to manufacture in advance structures of determined height that are thermally equipped and ready for integration of electronic devices 50, in step 106, which reduces the time between design and manufacture of the satellite.

For the invention as a whole, the person skilled in the art understands that it concerns rigid heat pipes. The flexible heat pipes which are necessary in documents EP 3,003,862 and U.S. Pat. No. 5,735,489 are not recommended in a support structure according to the present invention, given their additional cost and their lower performance.

1. A support structure for a spacecraft, comprising a first side wall, a second side wall which is parallel to and opposite the first side wall, the first side wall being a wall among a North wall and a South wall, the second side wall being the other wall among a North wall and a South wall, a third side wall attached to at least the first side wall, and a fourth side wall which is parallel to and opposite the third side wall, the first side wall and the second side wall each being equipped with a radiator, wherein the support structure further comprises:
at least one interior panel attached between and perpendicular to the first side wall and to the second side wall, the interior panel being positioned equidistant from the third side wall and from the fourth side wall; when the spacecraft containing the support structure is in orbit around the Earth, the interior panel is positioned so as to contain a vector (V) directed towards the Earth; the interior panel has a main face and an opposite main face;
at least one first heat pipe that is L-shaped, having a first branch bearing against the second side wall and a second branch attached to the interior panel, the second branch of the first heat pipe having in its rectilinear portion a length greater than 80% of the distance between the first side wall and the second side wall;
electronic devices arranged on and in direct thermal contact with at least a portion of said first heat pipe.

2. The support structure according to claim 1, further comprising at least one second heat pipe that is L-shaped, having a first branch bearing against the first side wall and a second branch against the interior panel, the second heat pipe being able to exchange heat with the first heat pipe, said support structure further comprising electronic devices arranged on and in direct thermal contact with said second heat pipe.

3. The support structure according to claim 2, wherein the second branch of the second heat pipe is in direct thermal contact with the second branch of the first heat pipe, the second branch of the second heat pipe being attached against the second branch of the first heat pipe.

4. The support structure according to claim 2, wherein the second branch of the first heat pipe is attached against the main face of the interior panel and wherein the second branch of the second heat pipe is attached against the opposite face of the interior panel.

5. The support structure according to claim 1, wherein the second side wall comprises a first zone and a second zone which are delimited by the interior panel, the first branch of the first heat pipe bearing against the first zone of the second side wall, the second branch of the first heat pipe being attached to the main face of the interior panel, said support structure further comprising a first additional heat pipe having a first branch bearing against the second zone of the second side wall and a second branch attached against the opposite main face of the interior panel.

6. The support structure according to claim 1, further comprising rectilinear heat transfer devices attached to said second side wall, the first heat pipe being attached against said heat transfer devices and being in direct thermal contact with said heat transfer devices.

7. The support structure according to claim 2, further comprising rectilinear heat transfer devices attached to said first side wall, said at least one second heat pipe being attached to said heat transfer devices and being in direct thermal contact with said heat transfer devices.

8. The support structure according to claim 1, further comprising a first main antenna and a second main antenna, said electronic devices comprising a first amplifier attached to the first side wall and connected to the first main antenna a second amplifier attached to the second side wall and connected to the second main antenna, and a single redundant amplifier attached against the interior panel and connected to the first main antenna and to the second main antenna.

9. The support structure according to claim 1, wherein the first branch of one among the first heat pipe and the second heat pipe has a length between 0.5 meters and 1.5 meters.

10. The support structure according to claim 1, wherein the second branch of the first heat pipe has a length between 2 meters and 2.7 meters.

11. The support structure according to claim 1, wherein the second branch of the second heat pipe has a length between 1 meter and 1.5 meters.

12. A method of assembling a support structure for a spacecraft, starting with a first side wall, a second side wall, an interior panel having a main face and an opposite main face, and at least one first heat pipe having a first branch and a second branch, the second branch of the first heat pipe having in its rectilinear portion a length greater than 80% of the distance between the first side wall and the second side wall, the method comprising the following consecutive steps:
a) attaching said interior panel between and perpendicular to the first side wall and to the second side wall, the interior panel being positioned so as to contain a vector (V) directed towards the Earth, when the spacecraft containing the support structure is in orbit around the Earth,
b) mounting the first branch of said at least one first heat pipe so as to bear against the second side wall and attaching said second branch of said at least one first heat pipe to the interior panel,
c) attaching electronic devices against the first branch of said at least one first heat pipe, and attaching electronic devices against at least a portion of the second branch of said at least one first heat pipe, and
e) connecting the electronic devices by electrical connections, at least one electronic device attached to the interior panel being electrically connected to an electronic device attached to the first side wall,
f) testing electrical connections between the electronic devices.

13. The method according to claim 12, which further comprises a step of mounting the first branch of at least one second heat pipe so as to bear against the first side wall and of attaching the second branch of said at least one second heat pipe against, and in direct thermal contact with, a portion of the second branch of the at least one first heat pipe; said attachment step being implemented between mounting step b) and attachment step c); electronic devices being attached to the first side wall against the first branch of the second heat pipe, and on the interior panel against the second branch of the second heat pipe, during attachment step c).

14. The method according to claim 12, wherein the interior panel comprises at least one through-hole and wherein the method further comprises a step of establishing at least one electrical connection between at least one electronic device attached to the main face of the interior panel and an electronic device attached to the opposite main face of the interior panel; said electrical connection passing through said through-hole.

15. The method according to claim 12, wherein electronic devices are attached over the whole of the second branch of said at least one first heat pipe during attachment step c).

16. The support structure according to claim 1, wherein the first branch of one among the first heat pipe and the second heat pipe has a length between 0.7 meters and 1 meter.

17. The support structure according to claim 9, wherein the second branch of the first heat pipe has a length between 2.4 meters and 2.7 meters.

18. The support structure according to claim 1, wherein the second branch of the second heat pipe has a length between 1.2 meters and 1.4 meters.
